(19) United States
(12) Patent Application Publication
(10) Pub. No.: US 2018/0099337 A1
(43) Pub. Date: Apr. 12, 2018

(54) Devices for Broken Drill Bit Removal

(71) Applicant: Ray Fitzgerald Woods, Salem, OH (US)

(72) Inventor: Ray Fitzgerald Woods, Salem, OH (US)

(21) Appl. No.: 15/727,627

(22) Filed: Oct. 8, 2017

Related U.S. Application Data
(60) Provisional application No. 62/405,911, filed on Oct. 8, 2016.

(51) Int. Cl. B23B 51/02

(52) U.S. Cl. CPC B23B 51/02; B23B 49/001; B23B 2251/40

(57) ABSTRACT

Devices for broken drill bit removal are provided herein. The drill bit includes a center through hole situated longitudinally and interiorly in the drill bit. A wire rope first end is welded to a cutting tip of the drill bit and retained freely within the walls of the center through hole and said wire rope having a stop attached at a second end. Should the drill bit be compromised, leaving the portion of drill bit head lodged in the bore, the pieces of drill bit are still connected via said wire rope and the lodged portion can be easily and quickly removed by pulling and backing out the powered device that was driving the drill bit thus alleviating the necessity of EDMing the broken drill bit out of the bored component.

### CROSS REFERENCE TO RELATED APPLICATIONS

This application claims priority from U.S. Provisional Patent Application No. 62/405,911 filed Oct. 8, 2016 with the United States Patent and Trademark Office. The disclosure of which is incorporated herein.

### BACKGROUND

### 1. Field

The present invention relates to the traditional drill bits and tools of the like used for cutting holes in various materials such as wood, metal, plastic, concrete, rock and earth. The present invention is geared more specifically toward extracting a broken drill bit out of a hole.

### 2. Description of Related Art

Conventional drill bits are defined by length, material, shape, and the material they cut. Drill bits are formed with one or more cutting surfaces, usually formed at the tip of the bit, can have one or more s, and most often made of steel. Drill bits are used for cutting holes in various materials and are driven by drill guns, CNC machines, drill rigs and, in some cases, by hand. In the event the drill bit isn't started correctly, binds on the shavings from cutting, gets too hot due to a lack of lubricant reaching the cutting surface of the bit, or binds on a rock, the drill bit can bind and break leaving a piece of the drill bit in the hole. Due to the material they are constructed of and the heat-treating process performed on a drill bit to harden the metal material to a defined specification for cutting various materials, the drill bit can become somewhat brittle. In the event a drill bit breaks off in a hole, it is difficult to retrieve the piece of drill bit left in the hole and commonly the bored component is set aside, to be addressed at a later time. In the case of earth drilling, the drilling head is attached to long hollow shafts and if the drill shafts break, the drilling head, which is very expensive, is lodged deep within the earth and in most cases is unable to be retrieved.

Many different drill bits and other cutters have been patented solving various problems attributed to cutting holes, see for example U.S. Pat. Nos. 1,467,491, 2,936,658, 3,597,817, 3,806,270, 3,861,011, 4,594,034, 4,602,900, 4,756,650, 4,826,368, 4,913,603, 5,297,456, 5,382,121, 5,931,615, 6,045,301, 6,988,859 and 9,403,246.

Prior art in U.S. Pat. No. 1,467,491 a “Twist Drill”, the drill can be operated at higher operating speeds without overheating.

In U.S. Pat. No. 2,936,658, a drill was created to eliminate having to predrill a pilot hole and the need of using progressively larger drill diameters to achieve a larger diameter hole.

A Tee-slot Cutter and Method for using it in U.S. Pat. No. 3,597,817 has oil holes to transport oil/lubricant from the base of the drill to the drill cutter head.

U.S. Pat. No. 3,806,270 “Drill for Drilling Deep Holes” issued Apr. 23, 1972 was invented for drilling holes which were long in relation to their diameter.

U.S. Pat. No. 3,861,011 granted Jan. 21, 1975, Milling Cutter, is a blade milling cutter with cemented carbide herical inserts are placed within a plurality of grooves formed around the cutter body.

Prior art in U.S. Pat. No. 4,594,034, is a Multigroove Drill Bit with Angled Frontal Ridges that has a shaft with at least three flutes forming respective lateral cutting edges and as many generally radial frontal ridges.

A “Micro Drill with Modified Drill Point” U.S. Pat. No. 4,602,900, discloses a micro drill with a modified point in which the drill is formed from a rigid cylinder and has two opposed helical wings and helical edges.

U.S. Pat. No. 4,756,650, a “Twist Drill”, has a body characterized by the outer portion of each of the heels bulging toward the main flute as compared with that of the standard twist drill.

Yet another U.S. Pat. No. 4,826,368 also entitled “Twist Drill” has a longitudinal axis and major flanks ground by helical face grinding.

A “Spiral Drill” in U.S. Pat. No. 4,913,603 is a two-flute drill bit that includes two drill webs each provided with a cutting tip.

Prior art in U.S. Pat. No. 5,297,456, a “Cutting Tool with Twisted Edge and Manufacturing Method Thereof” teaches that the blade part of the tool comprises the base sintered body having a twisted groove in the position of forming the twisted edge on the outer circumference.

A “Drill Bit for Use in Concrete and Asphalt”, U.S. Pat. No. 5,382,121, is used to drill holes in concrete and asphalt where pressurized air is injected into the drilled hole through helical grooves in the extractor.

U.S. Pat. No. 5,931,615 entitled “Twist Drill Bit” has one flute being provided with an outer cutting edge segment and a second flute being provided with an inner cutting edge segment.

Prior art in U.S. Pat. No. 6,045,301, discloses a drill with at least one central channel for cooling/lubricant oil feed.

U.S. Pat. No. 6,988,859 issued Jan. 24, 2006, has a ridge tree configuration that reduces mechanical stress during drilling to a minimum.

Lastly, U.S. Pat. No. 9,403,246 offers a “Drill Bit and Method for Manufacturing” that creates a clearance that becomes continuously larger as the distance from the point of intersection of a secondary cutting edge where the drill-bit back increases.

Accordingly, it is evident these patents and conventional drills do not address the possibility of the drill bit breaking off in a hole and the tedious work involved in removing the remaining piece of drill bit in the bored component. Therefore it would be advantageous to provide a drill with an integrated fail-safe component allowing for easy removal of the broken drill bit.

### BRIEF SUMMARY OF THE INVENTION

To alleviate the disadvantages of prior art, a drill bit is provided herein. The present invention comprises utilizing a majority of drill bits on the market used for cutting a hole in various materials such as wood, metal, plastic, concrete, earth and rock. For drills that provide holes in wood, metal, plastic, or concrete; a shank of the drill bit has flats and is used in conjunction with a powered hand drill, drill press, or CNC machine. A body of the drill bit if used for hole drilling in metal, wood, plastic, or concrete contains one or more chip flutes that help remove debri from a cutting tip. Along the outer edge of the flutes can be lips that also cut away material. The cutting tip is at the opposite end from the shank. The cutting tip can be machined on the drill bit or the cutting tip can be made separate of the drill bit and attached to the drill bit. The drill-bit cutting tip can be machined in different shapes and angles. The flutes and lips can be in multiples or singular, have different depths and lengths, and have a more or less aggressive spirals and diameters.

Where earth drills for water, gas and oil wells are utilized, a drill-bit head is attached to a lengthy pipe that is threaded on both ends, one end having male threads and the other end having female threads; where multiple pipes can be threaded together to achieve a desirable depth. If the aforementioned drill head becomes bound by a rock or dense vein of material the drill pipe can become compromised and break leaving behind the cutting head lodged deep within the earth, which creates a substantial financial loss for the driller.

The present invention comprises the aforementioned conventional drill bits having a hole longitudinally located through the center of the drill bit. The machined center hole can be a through hole or a blind hole either of which have at least one opening, beginning in the shank end and running all the way through the body of the drill bit and can exit the body of a drill bit that receives a cutting tip or stop short of the cutting tip. A wire rope longer than the aforementioned center hole is permanently attached to the cutting tip of the drill bit or within the body of the drill bit close to the cutting tip. If the drill bit tip is machined from the body of the drill bit, the hole will be a blind hole and the wire can be welded to and within the bottom of the hole or secured to the same utilizing a permanently affixed bearing or sprag bearing that is held in place by the walls of the hole. The wire can be welded or have a stop to retain the wire within the bearing or sprag bearing. The wire rests in the center hole of the drill bit body with a small portion protruding out of the shank end. The protruding portion of wire can be fed up through a spring, washer, bearing and/or sprag bearing where the wire receives a stop. A plastic or metallic sleeve can also be inserted within the machined hole of the drill bit, where the wire would pass through before entering into the spring, washer, bearing and/or sprag bearing. In the event the drill bit breaks while in use, and the tip becomes lodged in the drilled hole; the shank, body and tip of the drill bit are still connected by the same wire running through the center of the drill bit. While the tip lodged in the drilled hole is then stationary, the remaining body and shank can still spin freely as it is still being mechanically driven by whichever means the operator chose. If the metallic or plastic sleeve was inserted in the drilled hole, the sleeve will help protect the wire from becoming pinched or distorted if the drill bit breaks. The drill bit and lodged broken portion can then easily be removed from the drilled hole by simply pulling the drilling device back and the wire within the drill bit will pull out all of the broken drill bit. As one skilled in the art can see this will save the operator from down time and added expense currently required for the tedious removal of a piece of drill bit or completely discarding the component containing the broken piece of drill bit.

The above discussed embodiments of the present invention will be described further hereinbelow with reference to the accompanying figures.

### BRIEF DESCRIPTION OF THE DRAWINGS

FIG. 1 is a perspective view of the current invention, a drill bit with a through center hole containing a free standing wire rope welded to a detachable cutting tip of the drill bit and retained in the center hole of the drill bit, by a stop attached at the top of the wire rope.

FIG. 2 is a perspective view of the current invention broken and exposing the wire rope retained within the center hole of the drill bit.

FIG. 3 is a perspective view of a drill bit with a through center hole containing a wire rope held within the drill bit with a stop at either end of the wire rope and a spring, washer and bearing assembly with the drill bit having a detachable cutting tip.

FIG. 4 is a perspective view of the current invention having a blind hole stopping short of a drilling tip of a drill bit

FIG. 5 is a perspective view of a wire rope, washer, bearing, spring, and insert sleeve assembly to be inserted into a blind center hole of a drill bit.

FIG. 6 is another perspective view of a wire rope, washer, sprag bearing, spring, and a two piece insert sleeve assembly.

FIG. 7 is a perspective view of a drill bit machined to accept the two piece insert sleeve assembly.

### REFERENCE NUMERALS IN TI-IF DRAWINGS

| | | | |
|---|---|---|---|
| 2 | Drill Bit | 4 | Center Hole |
| 6 | Wire Rope | 8 | Stop |
| 10 | Weld | 12 | Cutting Tip |
| 16 | Shank | 18 | Washer |
| 20 | Bearing | 22 | Sprag Bearing |
| 24 | Spring | 26 | Insert Sleeve |
| 44 | Blind Hole | 46 | Chip Flute |
| 48 | Two piece Insert Sleeve | 50 | Splines |
| 52 | Groove | 54 | Upper Sleeve |
| 56 | Lower Sleeve | | |

### DETAILED DESCRIPTION OF THE PREFERRED EMBODIMENTS

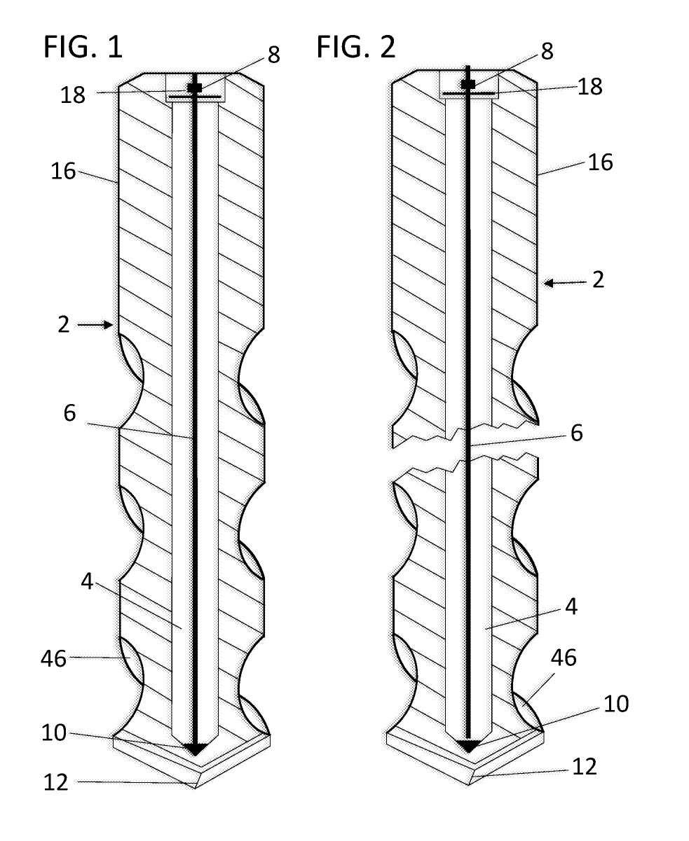

FIG. 1 shows a drill bit 2 as taught by the current invention, which has a shank 16, at least one chip flute 46, a cutting tip 12, a machined center hole 4, and a wire rope 6 running through the center hole 4. Drill bits 2 are made from metal and undergo a heat-treating process to further strengthen the metal of the drill bit 2. The center hole 4 runs interiorly of the drill bit 2 along a longitudinal axis thereof. It is preferred that the present invention has the center hole 4 machined into the drill bit 2 prior to the heat-treating process but can be machined after the heat-treating process if necessary. The preferred shape of the center hole 4 is round but can be square, hex, and triangular shaped without departing from the spirit of the invention. The shank 16 of the drill bit 2 is adapted with flats to be gripped by a rotary machine (ex. Hand drill, CNC drill etc.) used for drilling, and is a first a end of the drill bit 2, where a larger diameter hole is machined concentrically with the center hole 4 at a short depth therein. The at least one chip flute 46 runs in a spiral around the longitudinal center axis of the drill bit 2. In FIG. 1, the cutting tip 12 is a detachable tip and is affixed to a drill bit 2 second end. It can be seen that the center hole 4 is a through hole from the first end of the drill bit 2 in the shank 16, to the second end of the drill bit 2 opposite the shank 16. The wire rope 6 first end is affixed to the cutting tip 12 via weld 10, and the cutting tip 12 affixed to the drill bit 2 second end by a weld 10. A second end of said wire rope 6 is inserted into said center hole 4 of the drill bit 2 and slid all the way through until it protrudes from the shank 16 end of the drill bit 2. A washer 18 and then a stop 8 is installed on said second end of the wire rope 6 and the wire rope 6 with the washer 18 and stop 8 is situated and resting in the larger diameter hole of the drill bit 2. Said stop 8 and weld 10 retain the wire rope 6 within the center hole 4 of the drill bit 2. The washer 18 and stop 8 keep the wire rope 6 in place.

Pictured in FIG. 2, if the drill bit 2 is compromised and breaks off in a hole that is being drilled, said first end of the drill bit 2, will spin freely around the wire rope 6, washer 18 and stop 8 with said wire rope 6 welded 10 to the cutting tip 12 of the drill bit 2 which is lodged in the bore the drill bit 2 was cutting. The lodged portion of the drill bit 2 can be easily and quickly removed by pulling and backing out whichever device (powered hand drill, drill press or CNC machine etc.) the operator has chosen to rotate the drill bit 2. Because the wire rope 6 is permanently affixed to the cutting tip 12 and the cutting tip 12 is affixed to the drill bit 2 by way of weld 10 and said wire rope 6 retained within said larger diameter hole by a washer 18 and a stop 8 at the first end of the drill bit 2 when the device pulls out of the bore, the drill bit 2, in its entirety, is removed and a new uncompromised drill bit 2 can be placed in the device and the hole drilling can begin again without extended downtime or discarding of a bored component. Thus the operator saves substantial time and money.

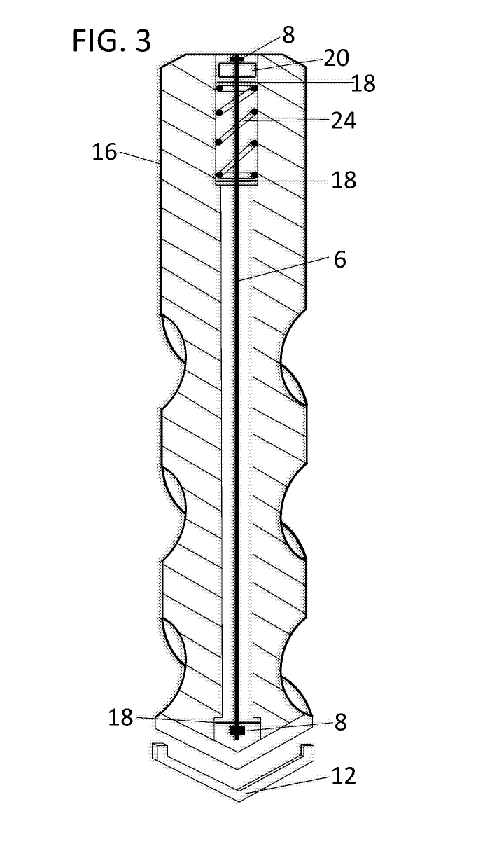

FIG. 3 depicts another variation of the preferred embodiments of the current invention. A drill bit 2 with a through center hole 4 and detachable cutting tip 12, where the wire rope 6 second end has a stop 8 and is passed through a bearing 20, washer 18, and a spring 24. This wire rope 6 assembly is then slid down through the center hole 4 until the first end of the wire rope 6 is in the second end of the drill bit 2, and the spring 24 is compressed as it is resting within the larger diameter hole so that the first end of the wire rope 6 is exposed and receives a second washer 18 and a second stop 8. The cutting tip 12 is then welded 10 to the second end of the drill bit 2. The first stop 8 that is seated on the bearing 20 allows for smooth rotation of the first end of the drill bit 2 around the wire rope 6 should it become compromised and broken within a bored hole.

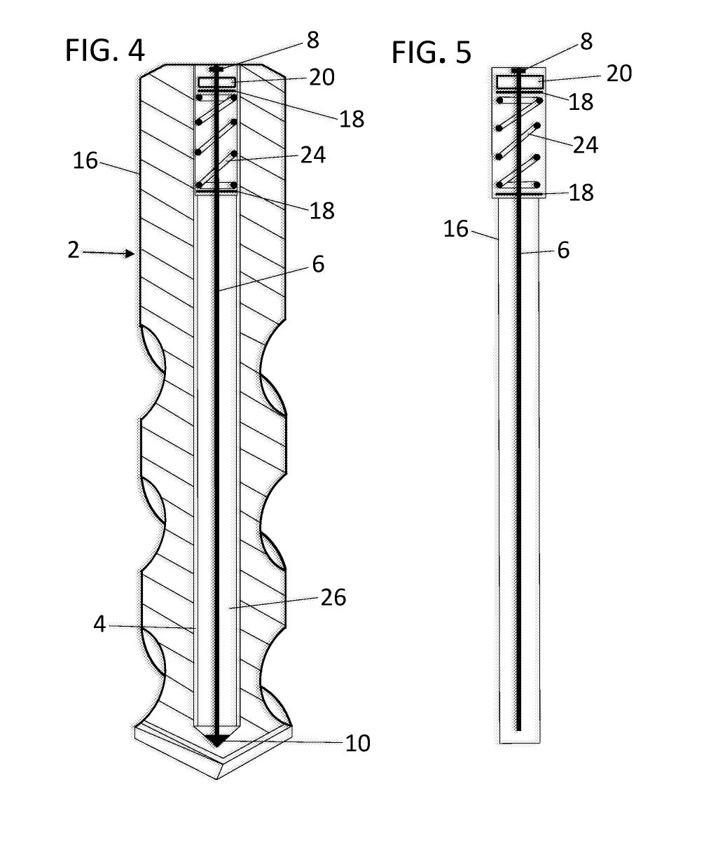

FIG. 4 illustrates a drill bit 2 with a blind hole 44 and where the cutting tip 12 is machined on the drill bit 2 and not detachable. The blind hole 44 is in the longitudinal axis of the drill bit 2. This variation of the preferred embodiments also has a larger diameter hole machined in the drill bit 2 first end and is concentric with the blind hole 44. FIG. 4 drill bit 2 receives a sleeved wire rope 6 assembly as pictured in FIG. 5. At the second end of the wire rope 6 is a stop 8, below the stop 8 is a first washer 18, below the first washer 18 is a bearing 20, beneath the bearing 20 is a second washer 18 and then a spring 24 where a first end of the wire rope protrudes. An insert sleeve 26 made of plastic, metal, or carbon fiber where plastic is the preferred embodiment in FIG. 5. The insert sleeve 26 is made as a hollow cylinder having a diameter just small enough to be inserted into the blind hole 44 and larger diameter hole of the drill bit 2 and the length is shorter than the depth of the blind hole 44 as depicted in FIG. 4. and FIG. 5. After the insert sleeve 26 is in the drill bit 2 blind hole 44, the wire rope 6 assembly of FIG. 5 is slid into the insert sleeve 26, where the spring 24 is then partially compressed causing the first end of said wire rope 6 to be in contact with the bottom of the blind hole 44 of the drill bit 2. The said first end of the wire rope 6 can then be welded 10 to the drill bit 2 via resistance spot welding. In the event the drill bit 2 breaks while boring a hole, the aforementioned spring 24 in the wire rope 6 assembly, can absorb some of the energy created if the shank 16 end jumps up and down on the uneven broken surface of the cutting tip 12 end lodged in the bored hole it was cutting until the drilling machine stops rotating completely. The bearing 20 allows for smooth rotation of the broken drill bit 2 shank 16 end around the wire rope 6.

Brazing can also be used to attach the wire rope 6 to the bottom of the blind hole 44 of the drill bit 2 pictured in FIG. 4 by placing brazing and flux in the bottom of the blind hole 44, heating the cutting tip 12 portion of the drill bit 2 and sliding the wire rope 6 with flux on its first end into the brazing and flux in the blind hole 44, then cooling the drill bit 2.

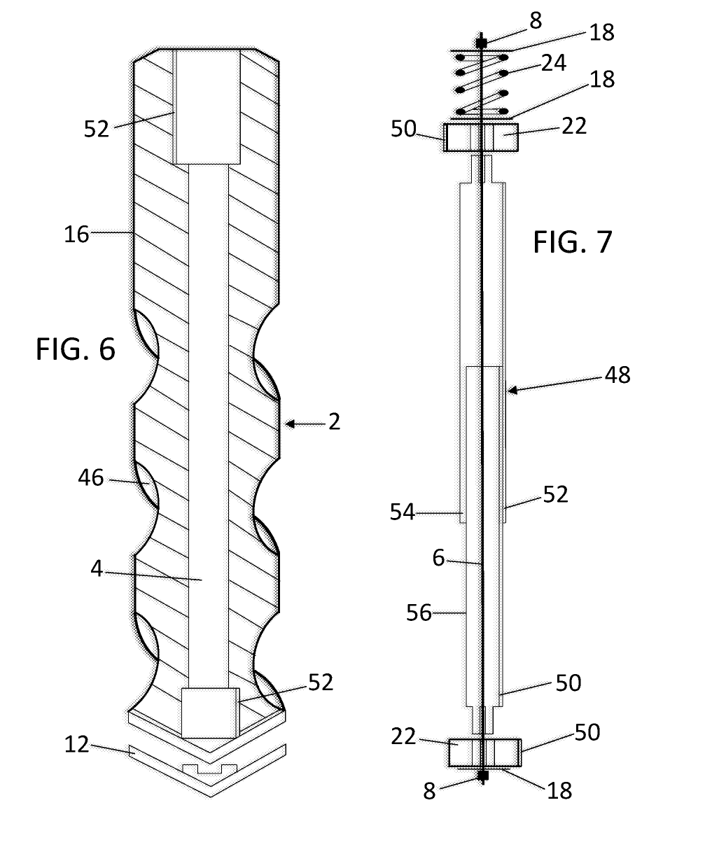

FIG. 6 features yet another variation of the preferred embodiments of the wire rope 6 assembly where a sprag bearing 22 replaces the bearing 20. It can be seen in FIG. 6 that a two piece insert sleeve 48 is the preferred embodiment to be used in conjunction with the sprag bearing 22. The two piece insert sleeve 48 is machined where an upper sleeve 54 is a hollow cylinder with at least one groove 52 in the inner diameter and a lower sleeve 56 of the two piece insert sleeve 48 is a hollow cylinder with at least one spline 50 on the outer diameter to mate with the groove 52 on the upper sleeve 54 of the two piece insert sleeve 48. Where both sleeve parts are concentric and can slide easily in and out of each other and each sleeves length is shorter than the length of the center hole 4 of the drill bit 2 that the sleeves will be inserted. When the two piece insert sleeve 48 is assembled, the at least one groove 52 and the at least one spline 50 are engaged between the upper sleeve 54 and lower sleeve 56 therein and when rotated both portions will rotate together. The upper sleeve 54 first end has a smaller diameter with at least one spline 50, a first sprag bearing 22 with at least one groove 52 on an inner diameter is machined to accept the at least one spline 50 of the upper sleeve 54 first end. The first sprag bearing 22 has at least one spline 50 on the outside diameter thereof. The lower sleeve 56 first end has a smaller diameter with at least one spline 50, a second sprag bearing 22 with at least one groove 52 machined on the inside diameter thereof, to accept the at least one spline 50 of the lower sleeve 56 first end. The second sprag bearing 22 has at least one spline 50 on the outside diameter thereof. Above the first sprag bearing 22 rests a first washer 18, a compression spring 24 where a second washer 18 rests on the spring 24 and a wire rope 6 first end is inserted into a hole of the second washer 18, through the spring 24, the first washer 18 and the sprag bearing 22 and the upper sleeve 54 of the two piece insert sleeve 48. The wire rope 6 second end has a stop 8 attached to prevent the wire rope 6 second end from sliding through the hole in the washer 18. The lower sleeve 56 of the two piece insert sleeve 48 is slid into the upper sleeve 54 therein and the wire rope 6 is slid through the lower sleeve 56 second sprag bearing 22, a third washer 18 and out the end thereof and a second stop 8 is attached to the first end of the wire rope 6 creating a completed two piece insert sleeve 48 assembly. The two piece insert sleeve 48 can be partially assembled out side the drill bit 2 but the affixing of the second stop 8 and the mating of the upper sleeve 54 and lower sleeve 56 can not take place until both sleeve pieces are inserted from opposite ends into a drill bit 2 and the first end of the wire rope 6 is protruding from the second end of the drill bit 2 where the second stop 8 is attached. Depicted in FIG. 7 is a drill bit 2 machined to receive the two piece insert sleeve 48 assembly. The drill bit 2 is machined with a through center hole 4 in the longitudinal axis of the drill bit 2, where there are two larger diameter holes concentrically machined on the same longitudinal axis as the center hole 4. A first larger diameter hole is in the shank 16 end of the drill bit 2 and a second larger diameter hole is on the opposite end of the drill bit 2. Each of the larger diameter holes have a least one machined groove 52 to accept the at least one spline 50 of the first and second sprag bearings 22. The upper sleeve 54 portion with sprag bearing 22, first washer 18 spring 24, second washer 18, and wire rope 6 with a stop 8 on the wire rope 6 second end is inserted into the first end of the drill bit 2 and the lower sleeve 56 is then inserted from the second end of the drill bit 2 and slid into the upper sleeve 54, where the wire rope 6 is then protruding from the second end of the drill bit 2 and the third washer 18 and a second stop 8 is then affixed to the first end of the wire rope 6. In the event the drill bit 2 with the two piece insert sleeve 48 assembly is compromised while drilling a bore in a component and breaks, the sprag bearings 22 allow the shank 16 portion to spin freely around the wire rope 6 until the machine rotating the drill bit 2 stops rotating. If the entire drill bit 2 does not easily pull out of the bored hole; the machine the drill bit 2 is chucked up to can be reversed, and the sprag bearings 22, affixed on the two piece insert sleeve 48 assembly and retained in the larger diameter holes of the drill bit 2 via at least one spline 50 and at least one groove 52, cause the drill bit 2 to back out of the bored hole because the sprag bearings 22 slip in the drilling direction and grab in the reverse direction. The upper sleeve 54 and lower sleeve 56 when assembled in the drill bit 2, rotate in unison as a single sleeve because of the spline 50 and groove 52 on their interior and exterior. When the drill is reversed the two piece insert sleeve 48 rotates as one with the drill bit 2 because the sprag bearings 22 become engaged and do work. It should be noted that the current invention can be incorporated in twist drills, step drills, counter and spotting drills, core drills, ejector drills and gun drills and the order of the preferred embodiments can be arranged in multiple variations; those skilled in the art can appreciate there can be multiple splines 50 and grooves 52, and the same can be machined in multiple shaped and size variations without departing from the spirit of the invention.

Having described my invention clearly and concisely, I claim:

1. A hole cutting drill bit:
A drill having a longitudinal axis, said drill comprising:
A shank end, a fluted portion and a cutting tip;
said shank end is a first end of the drill bit and ends at the fluted portion;
said fluted portion further defined by having at least one chip flute, where the chip flute is disposed and configured in a spiral around the longitudinal axis of the drill bit; and
said chip flute is to remove chips from said cutting tip; and
said chip flute is disposed at said cutting tip attachment point; and
said cutting tip is adapted to be attached to said fluted disposed end; and
where a through center hole is machined along the longitudinal axis of the drill bit; and
said through center hole first opening is in the shank end where a larger diameter pilot hole is and said through center hole second opening is where the chip flutes are disposed; and
said larger diameter pilot hole is concentric with said through center hole; and
a wire rope has a first and second end and is longer than said through hole of the drill bit; and
said wire rope first end is welded to said cutting tip and said cutting tip is to be welded to where said at least one chip flute is disposed; and
said second end of the wire rope is slid through the through center hole of the drill bit to exit the shank end of the drill bit; and
said wire rope second end is inserted through a washer; and
said washer is just smaller than said larger diameter pilot hole and said washer rests therein; and
where the second end of the wire rope then receives a stop and said stop is further defined as being larger in diameter than the diameter of the hole in the washer.

2. The drill bit of claim 1 where;
The said chip flute end of said drill bit has a second machined larger diameter pilot hole and said second machined larger diameter pilot hole is concentric with said through center hole of the drill bit and first machined larger diameter pilot hole; and
said wire rope second end has a first stop and said first end of the wire rope is slid through a bearing, then a first washer, then spring and a second washer and; where
said wire rope first end is slid through said longitudinal through center hole of said drill bit to exit the said chip flute end where said first end of wire rope passes through a second washer and a second stop is then affixed thereon; and
where said second washer is just smaller in diameter than that of said second larger diameter pilot hole of said drill bit; and
said second stop is further defined as being larger in diameter than the hole of said second washer; and
where said cutting tip is then welded to where the chip flute is disposed.

3. The drill bit of claim 1 where:
said drill bit is chucked in a rotary machine and rotated to bore a hole; and
said drill bit is compromised and broken; and
said drill bit shank is able to rotate around said wire rope; and
where said cutting tip and broken chip flute portion do not rotate in said bored hole but said wire rope remains intact on said shank portion and said broken chip flute and cutting tip portion; and
where said wire rope links said shank portion and broken chip flute and cutting tip portions; and
said broken drill bit shank, chip flute and cutting tip portions can be removed as one embodiment by withdrawing said rotary machine where said drill bit is chucked.

4. The drill bit of claim 2 where:
said drill bit is chucked in a rotary machine and rotated to bore a hole; and
said drill bit is compromised and broken; and
said bearing allows smooth and easy rotation of said drill bit shank around said wire rope; and
said spring allows for some vertical oscillating of the broken drill bit until rotation ceases; and
where said cutting tip and broken chip flute portion do not rotate in said bored hole but said wire rope remains intact on said shank portion and said broken chip flute and cutting tip portion; and
where said wire rope links said shank portion and broken chip flute and cutting tip portions; and
said broken drill bit shank, chip flute and cutting tip portions can be removed as one embodiment by withdrawing said rotary machine where said drill bit is chucked.

5. A hole cutting drill bit:
A drill having a longitudinal axis, said drill comprising:
A shank end, a fluted portion and a cutting tip;
said shank end is a first end of the drill bit and ends at the fluted portion;
said fluted portion further defined by having at least one chip flute, where the chip flute is disposed and configured in a spiral around the longitudinal axis of the drill bit; and
said chip flute is to remove chips from said cutting tip; and
said cutting tip is the further defined as a second end of the drill bit and is one thereof; and
where a blind center hole is machined along the longitudinal axis of the drill bit; and
said blind hole is disposed within the drill bit just above said cutting tip; said
said blind center hole opening is in the shank end where a larger diameter pilot hole is in said drill bit; and
said larger diameter pilot hole is concentric with said blind center hole; and
where a wire rope first end is slid through a first washer, then a bearing, a spring, then a second washer, and a plastic insert sleeve; and
where said insert sleeve is a cylinder with two open ends where a first end of said insert sleeve is a larger diameter then a body diameter of said insert sleeve and where said plastic insert sleeve is adapted to slide inside said larger diameter pilot hole of said drill bit and said blind center hole of said drill bit; and
where said plastic insert sleeve has a shorter length than said blind center hole in said drill bit; and
where said plastic insert sleeve is inserted into said blind hole of said drill bit; and
said plastic insert sleeve having a diameter smaller than said blind center hole and said larger diameter pilot hole of said drill bit; and
where said plastic insert sleeve is slid near a bottom of said blind hole; and
where said wire rope second end has a stop affixed and said stop has a larger diameter than a diameter hole in said washer; and
where said spring is partially compressed and said wire rope first end meets said bottom of said blind center hole of said drill bit; and
where a resistance spot weld permanently affixes said wire rope first end to said bottom of blind center hole of said drill bit.

6. The drill bit of claim 5 where:
said bottom of said blind center hole in the drill bit has flux and braze prior to installation of said wire rope first end; and
said first end of said wire rope receives flux; and
where said cutting tip of the drill bit is heated from an exterior of said cutting tip; and
where said first end of the wire rope with flux is inserted into said brazing and flux in the bottom of the blind center hole in said drill bit; and
where upon said brazing permanently affixes the first end of said wire rope; and
where said cutting tip is quickly cooled to complete said brazing.

7. The drill bit of claim 5 where:
said plastic insert sleeve creates non metallic surface to protect said wire rope from contacting an interior surface of the blind center hole until it reaches said bottom of the blind center hole of the drill bit, so that resistance spot welding is successful.

8. The drill bit of claim 5 where:
said drill bit is chucked in a rotary machine and rotated to bore a hole; and
said drill bit is compromised and broken; and
said bearing allows for smooth and easy rotation of said drill bit shank around said wire rope; and
said spring allows for some vertical oscillating of the broken drill bit until rotation ceases; and
where said cutting tip and broken chip flute portion do not rotate in said bored hole but said wire rope remains intact on said shank portion and said broken chip flute and cutting tip portion; and
where said wire rope links said shank portion and broken chip flute and cutting tip portions; and
said broken drill bit shank, chip flute and cutting tip portions can be removed as one embodiment by withdrawing said rotary machine where said drill bit is chucked.

9. A hole cutting drill bit:
A drill having a longitudinal axis, said drill comprising:
A shank end, a fluted portion and a cutting tip;
said shank end is a first end of the drill bit and ends at the fluted portion;
said fluted portion further defined by having at least one chip flute, where the chip flute is disposed and configured in a spiral around the longitudinal axis of the drill bit; and
said chip flute is to remove chips from said cutting tip; and
said chip flute is disposed at said cutting tip attachment point; and
said cutting tip is adapted to be attached to said fluted disposed end; and
where a through center hole is machined along the longitudinal axis of the drill bit; and
said through center hole first opening is in the shank end where a first larger diameter pilot hole is and said through center hole second opening is where the chip flutes are disposed; and
where a second larger diameter pilot hole is at said end of chip flutes are disposed; and
said first and second larger diameter pilot holes are concentric with said through center hole; and
said first and second larger diameter pilot holes in said drill bit each have at least one groove further defined as a recess; and
where a wire rope second end has a first stop and said first end of the wire rope is slid through a first washer, a spring and a second washer and a first sprag bearing; and
said first sprag bearing has a at least one spline on an exterior of said first sprag bearing and a at least one groove in an interior diameter of said first sprag bearing; and
where said first sprag bearing is affixed to an upper sleeve of a two piece insert sleeve; and
where said upper sleeve is further defined as a cylinder with at least one groove or recess along the length of a longitudinal wall of said upper sleeve and said upper sleeve first end has a smaller diameter than a body of said upper sleeve and said smaller diameter has a at least one spline adapted to slide into said at least one groove of the first sprag bearing; and
where a lower sleeve of the two piece insert sleeve is further defined as a cylinder with a at least one spline along the length of a longitudinal wall of said lower sleeve and has a diameter smaller than a second end of the upper sleeve and a second end of said lower sleeve is adapted to slide in the upper sleeve; and
where the at least one spline of said lower sleeve mates with said upper sleeve said groove; and
where the lower sleeve has a first end and said first end has a smaller diameter than a body of said lower sleeve and said smaller diameter has a at least one spline on an exterior of said lower sleeve smaller diameter; and
where a second sprag bearing has a at least one spline on an exterior of said second sprag bearing and a at least one groove in an interior diameter of said second sprag bearing; and
where said first end of said lower sleeve said at least one spline is adapted to mate with said at least one groove in the second sprag bearing; and
said upper and lower sleeves second ends are slid together and said wire rope first end is slid through the two piece insert sleeve, through the second sprag bearing, and a third washer where the first end of said wire rope receives a second stop; and
where said two piece insert sleeve is a carbon fiber or a steel; and
where the two piece insert sleeve must be inserted into said drill bit with the upper sleeve with said first sprag bearing affixed inserted into the shank end of said drill bit and said lower sleeve with second sprag bearing affixed inserted into said chip flute disposed end; and
where said first and second sprag bearings at least one splines mate with said larger diameter holes at least one grooves in said drill bit; and
where said wire rope first end is slid through the first washer, the spring, the second washer, the first sprag bearing, the upper sleeve, the lower sleeve, the second sprag bearing and third washer; and
where said wire rope first and second end each receive a stop and said cutting tip is then welded to where said chip flutes are disposed.

10. The drill bit of claim 9 where:
Said first and second sprag bearing slip when drilling a bore and work when reversed; and
where said two piece insert sleeve operate as one embodiment when said first and second sprag bearings work; and
where said two piece insert sleeve is as one embodiment with said drill bit when said first and sprag bearings work.

11. The drill bit of claim 9 where:
said drill bit is chucked in a rotary machine and rotated to bore a hole; and
said drill bit is compromised and broken; and
said first and second sprag bearings allow smooth and easy rotation of said drill bit shank around said wire rope; and
said spring and the upper and lower sleeves allow for some vertical oscillating of the broken drill bit until rotation ceases; and
where said cutting tip and broken chip flute portion do not rotate in said bored hole but said wire rope remains intact on said shank portion and said broken chip flute and cutting tip portion; and
where said wire rope, said two piece insert sleeve, with first and second sprag bearings link said shank portion and broken chip flute and cutting tip portions; and
said broken drill bit shank, chip flute and cutting tip portions can be removed as one embodiment by reversing and backing out said rotary machine where said drill bit is chucked.
